(19) United States
(12) Patent Application Publication
(10) Pub. No.: US 2020/0027166 A1
(43) Pub. Date: Jan. 23, 2020

(54) Risk-Adjusted Foreign Investment Method Using Hybrid Corporate Structure and Swaption

(71) Applicant: TCK Capital Partners, LLC, Baltimore, MD (US)

(72) Inventor: Harsha Kumar Aggarwal, Baltimore, MD (US)

(73) Assignee: TCK Capital Partners LLC, Baltimore, MD (US)

(21) Appl. No.: 16/039,978

(22) Filed: Jul. 19, 2018

(51) Int. Cl. G06Q 40/06; G06Q 40/04

(52) U.S. Cl. CPC G06Q 40/06; G06Q 40/04

(57) ABSTRACT

The invention is that of a method of investing in a foreign company, particularly in Australia, in a manner that confers unique benefits in terms of financial risk, corporate legal risk and tax treatment of investors. A search fund principal forms a limited liability company within the United States and enters the limited liability company into a limited partnership agreement with a foreign (preferably Australian) general partner and optionally one or more limited partners. The limited partnership registers with the foreign government (preferably Australia) as a venture capital limited partnership and is subject to Australian corporate law and not subject to Australia's thin capitalization rules. The limited partnership invests in the foreign company, preferably in Australia, by way of a convertible note. Investors in the limited liability company and limited partnership are able to receive certain returns on investment that are tax-exempt under Australian law.

### STATEMENT REGARDING FEDERALLY SPONSORED RESEARCH OR DEVELOPMENT

This invention was not made with federal government support.

### STATEMENT REGARDING PRIOR DISCLOSURES BY THE INVENTOR

The invention in whole or in part was disclosed by the inventor no earlier than Jul. 19, 2017. No other disclosure of the invention has been made.

### BACKGROUND OF THE INVENTION

The present invention is that of a method of making and managing foreign investments that leverages the protections of various domestic and foreign corporate structures in a unique way to achieve investment protection and financial gains. The invention is of particular utility to investors such as hedge funds, private equity funds and search funds—typically not startup company investors—investing in assets that are able to provide recurring cashflow at the time of purchase. In a preferred embodiment, the investment target company is organized under the laws of Australia and is subject to certain rules related to corporate governance and tax treatment that allow the target and its investors to take advantage of the benefits derived from the claimed corporate structure.

Historically, foreign investment vehicles have been susceptible to a number of different types of risks that do not apply to domestic investments. For example, financing direct investment in a foreign operating company is subject to currency exchange and interest rate risk that may be hedged but is difficult to eliminate. Strategies include using currency forward and futures contracts, currency call and put options, and other bespoke tools to purchase foreign currencies at periodic intervals in order to reduce day-to-day volatility in interest rates and currency markets. These strategies can provide benefits to investors in terms of risk management, but do not eliminate the currency risk associated with the full principal amount required for the foreign investment.

### BRIEF SUMMARY OF THE INVENTION

The present invention is an improvement to the process of US cross-border search fund investing in foreign business, and in a preferred embodiment, Australian business. The improvement is a unique combination of existing corporate legal structures that are employed to achieve the benefits described herein. The invention allows US investors to be subject to favorable foreign corporate law—Australian corporate law in a preferred embodiment—while remaining in the United States and allowing the search entrepreneur (the “searcher”) the maximum funding, domestic tax, and operating flexibility. By practicing the claimed invention, the foreign investment process is improved and risk is reduced, and in some cases, eliminated.

The invention is that of a method (comprising a unique three-way combination of three commonly used corporate structures and securities) of investing in an operating foreign company by making a debt-financed purchase of the target foreign company, which has positive operating cashflow, utilizing a specific corporate structure that allows the purchasing entity to initially eliminate the foreign governance legal risk, foreign corporate tax risk, interest rate risk, and the currency risk associated with the principal debt capital of the target purchase while benefiting from the ability of the target to fully deduct any interest paid on the debt repayment associated with the target purchase. The benefits of the invention described herein are only achievable by utilizing the claimed combination of corporate structures to facilitate foreign investment in the manner described herein.

In a preferred embodiment, an investor residing in a country that is party to a double-taxation treaty with the country in which the target resides forms a limited liability company (LLC) or equivalent, and the LLC enters into a limited partnership (LP) agreement, to which it becomes a limited partner with a general partner and optionally one or more other limited partners, wherein the general partner is a resident of the country where the foreign investment target is organized. The LP then conditionally registers as a venture capital limited partnership (VCLP) in the general partner's jurisdiction and enters into a currency exchange option agreement (commonly known as a cross-currency swaption, or simply “swaption”), the exercise term of which spans the term of the conditional VCLP registration. In a preferred embodiment, conditional VCLP registration in the foreign country of the target investment allows the VCLP two years to raise the money necessary to make the target investment.

By locking in a swaption to exchange currency at a specified exchange rate during a specified period, the uncertainty associated with future currency exchange rates that may fall into place before an investment in a foreign company is made is eliminated, allowing investors to exercise due diligence in the foreign investment target without running the risk that future exchange rates will diminish the value of investment in the target. In a preferred embodiment, the VCLP conditional registration and swaption periods are concurrent two-year periods.

In a preferred embodiment, the foreign investment target is organized under the laws of the Commonwealth of Australia. Under Australian law, a company may take on a debt obligation to a foreign investor and, subject to certain conditions, deduct any interest paid on payback of the investment principal from moneys owed to the foreign investor from Australian corporate income tax by virtue of the inapplicability of Australia's thin capitalization rules to the target due to control by the VCLP, the general partner of which is Australian. The ability to deduct interest from income tax obligations improves the returns on investment in the company for its investors, who also have derived benefits of eliminated and reduced interest rate and currency risk by exercising the swaption to fund investment in the target company. The ability to deduct interest from income tax obligations improves the returns on investment in the company for its investors, who also derived benefits of eliminated and reduced interest rate, currency exchange, and operating risks by exercising the swaption to fund investment in the target company and diversify their investment return sources.

### BRIEF DESCRIPTION OF THE DRAWINGS

FIG. 1A-1C illustrates various corporate structures a US investment group would use to practice the invention. In 1A, investors (1-4), including the searcher, each take an economic interest in an LLC (organized in Delaware in the example) for the purpose of searching for, identifying, negotiating, and consummating an agreement to make an acquiring investment in a foreign target. The LLC then enters a limited partnership agreement as a limited partner (LP) with a general partner (GP) that is located in the jurisdiction of foreign investment to form a fund (LPI Fund) to efficiently facilitate the foreign investment in the foreign target, as depicted in 1B. At 1C, a US bank loans money to a US firm which can exchange principal currency via an investment bank with an Australian or multinational firm funded by an Australian or other non-US bank in order to obtain Australian currency for investment in an Australian target. In a preferred embodiment, the currency exchange agreement is in the form of a swaption.

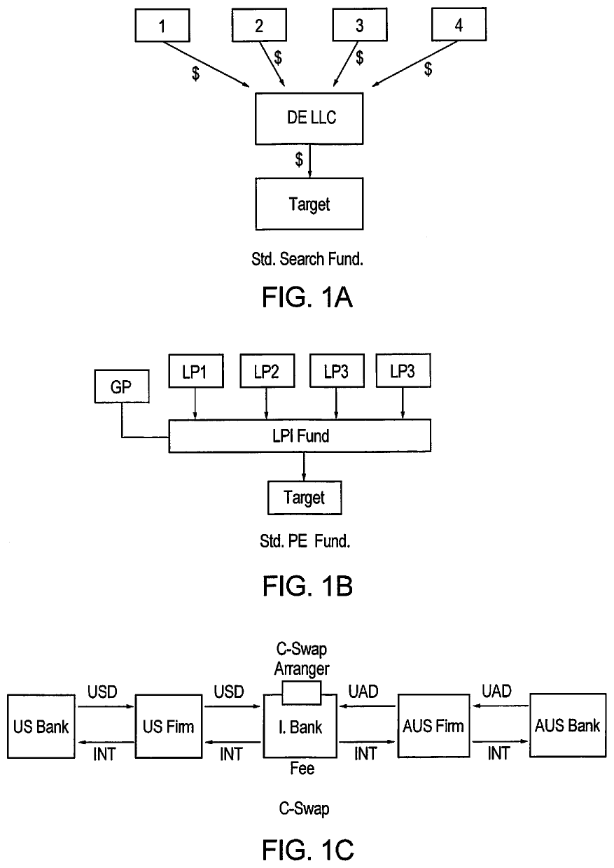

FIG. 2 illustrates the flow of investment funding under the model of the present invention. One or more search fund investors (SFIs) 200 contribute to a search fund LLC (SFM LLC) that forms an LP 201 with other investment (local and/or foreign) partners, including an Australian general partner 202 in the case of targeting Australian companies for investment.

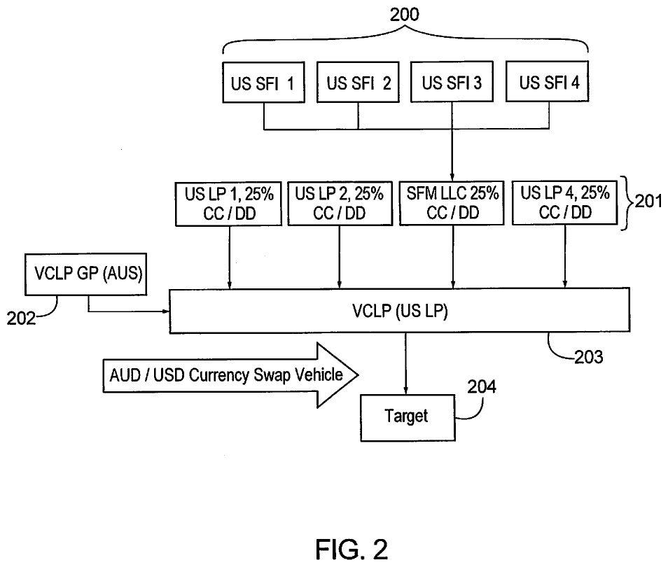

FIG. 3 illustrates the financing paradigm of the present invention, based on currency swap, resulting from the exercising the currency swaption (to enter into the swap). A fund (US LP) 301 is set up via partnership agreement among multiple US (and/or foreign) partners 300 interested in foreign investment as described herein. The fund 301 posts US currency from its own sources and/or a corporate debt provider 306 for exchange via a currency swap arranger such as an investment bank 303 for exchange with, for example, an Australian or multinational firm 304 interested in exchanging Australian currency for US currency at an agreed upon rate. The Australian currency received under the swaption is then invested in the Australian investment target 305.

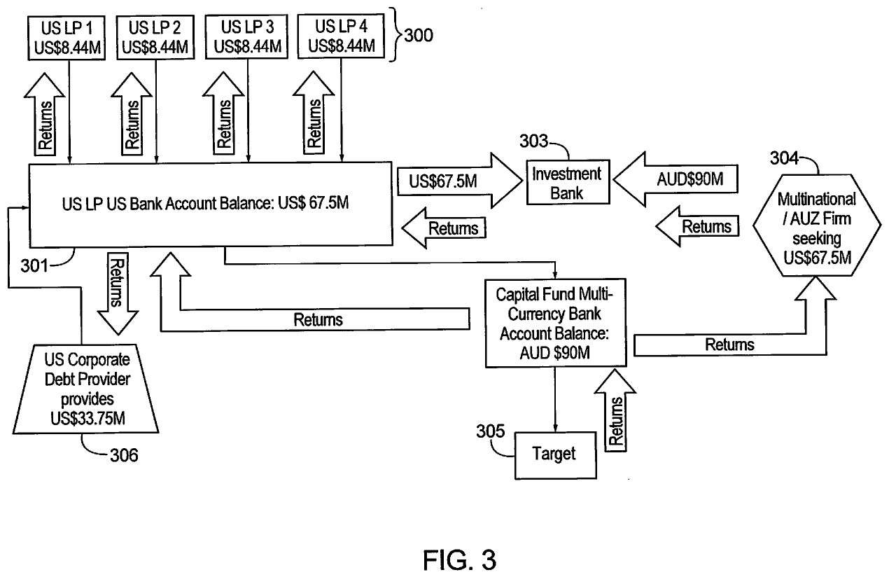

### DETAILED DESCRIPTION OF THE INVENTION

Various embodiments of the present disclosure generally relate to novel methods for making foreign investments in certain types of operating companies with unique incentives that reduce corporate taxes and increase returns on investment. The methods are particularly applicable to search funds: investment entities designed to raise money to search for and invest in a single business (as opposed to private equity investment in a portfolio of companies) that is vetted by the fund for approval by investors. Typically, the searcher is paid compensation for the service of identifying a suitable investment target, and also offered equity in the target once approved, to run the target (as opposed to private equity executives who take passive board positions of the investee portfolio companies).

In a preferred embodiment of the invention, investment is made by one or more US individuals or entities in a foreign company. In a preferred embodiment and by way of example and not limitation, the foreign company targeted for investment is organized under the laws of a foreign country that is party to a tax treaty with the United States to avoid or mitigate double taxation, which can be chilling to foreign investment. In a preferred embodiment, the foreign company targeted for investment is located in Australia, which is party to a Double Taxation Taxes on Income Convention Between the United States and Australia, which became effective in 1983.

Many States of the United States have enacted laws that enable individuals and businesses to form limited liability companies (LLCs), which are unique corporate structures that protect their members against personal liability for certain acts while allowing income to pass through the LLC to its members without being taxed. LLCs are comprised of members and operate in accordance with operating agreements or the like entered into by the members with each other, as opposed to shareholders of a corporation, who typically hold stock shares issued by the corporation. The LLC structure allows investors a great deal of flexibility and avoids some of the complexity and tax issues associated with corporations. In the context of the present invention, the LLC also preserves search fund structuring features that are not prevalent in the mainstream private equity industry and allows the maximum use of leverage when used in combination with the other structures recited herein as described herein. Effectively, the LLC allows investors (and the entrepreneur herself) to back an entrepreneur searching for a business investment with minimal capital commitments, which the partnership structures that are standard in the private equity industry do not allow. It is important to note that LLCs and LLC equivalents do not exist in all sovereigns, and particularly they do not exist in Australia.

In a preferred embodiment of the present invention, individuals or companies interested in practicing the methods of foreign investment described herein form an LLC by filing articles of organization or equivalent in the state of formation, and most preferably entering into an operating agreement or equivalent that governs the nature and conduct of business by the LLC. In a preferred embodiment, the LLC is organized under the laws of the State of Delaware. In a preferred embodiment, the nature of the business conducted by the LLC is that of a search fund, and particularly a search fund charged with the task of finding a suitable investment target in a non-US jurisdiction, most preferably Australia, for approval by its members. The US LLC allows the searchers to invest in themselves during the search stage of the investment process described herein, and receive the pass-through benefits of a limited partnership, which would not be possible without the LLC structure, and not possible with the C-corporation structure or the limited partnership structure.

A limited partnership (LP) is a business structure where two or more partners enter into an agreement to jointly carry out common business objectives, but one partner is a general partner and the others are limited partners. While the limited partners are only liable (i.e., for the debts of the partnership) up to the amount of capital each has invested in the partnership, the general partner's liability is not capped in that way. This enables the limited partners to benefit from positive cashflows of the business with limited liability. In a preferred embodiment of the invention, the LLC enters into a limited partnership agreement, as a limited partner, for a period of at least five years, with a general partner and optionally one or more other limited partners for the purpose of registering as a venture capital limited partnership (VCLP) in the foreign jurisdiction targeted for investment, most preferably Australia. By registering as a VCLP in Australia, for example, the LP becomes subject to Australian corporate law, which leads to the benefits described herein. A key benefit is that foreign investors in an Australian target business may retain local counsel in Australia to handle corporate legal issues that arise with respect to the target.

In a preferred embodiment, the LP is formed in a country that is party to a tax treaty with Australia, such as but not limited to the United States, and the general partner is an Australian individual or entity. This enables the LP to register in Australia as a VCLP—conditionally or unconditionally—to act as a pass-through entity to the benefit of its partners. Using this model, the VCLP can treat all investment receipts as capital gains as opposed to revenue, which reduces the tax burden on the returns on investments. In a preferred embodiment, the value of the investment target is capped at two-hundred fifty million Australian dollars in order to ensure VCLP treatment by the Australian tax authorities per the country's federal Venture Capital Act of 2002, the Corporations Act of 2001 and the Income Tax Assessment Act of 1997. In a preferred embodiment, the investment target is not in the business of property development, banking, financing, leasing, factoring, securitization, insurance, investing or construction.

In a preferred embodiment of the present invention, the VCLP registers conditionally with the Australian government. Conditional registration offers the registrant a period of two years during which it can ramp up its operations and raise the legal requisite ten million Australian dollars to operate the VCLP. In the case of the present invention, the two-year period is used to conduct due diligence on an Australian investment target and raise the money needed to purchase the asset before the expiration of the two-year period. Once the target asset is purchased the VCLP becomes the sole owner of the asset and its registration is no longer conditional.

In a preferred embodiment of the present invention, a currency swap option agreement (swaption) is entered into by the investment principals to lock in an option to exchange US dollars for Australian dollars at an agreed upon rate of interest and exchange, thereby eliminating the risk associated with money market volatility during the conditional period of VCLP registration. In a preferred embodiment, the investors can exercise the currency exchange at the agreed upon rate in order to finance the purchase of an Australian company targeted for investment. This risk elimination and mitigation aspect is a key feature of the present invention that is designed to attract investors. Typically, a swaption can be arranged for the investors by an investment bank, which will undertake finding Australian investors interested in exchanging Australian dollars for US dollars and facilitating a swap agreement and rates acceptable to the parties on each side of the transaction. Currency for funding the swap may belong to the investors or may be in the form of a bank loan or other corporate debt provision.

In addition to elimination and mitigation of risk associated with interest rate and currency exchange that can have a chilling effect on foreign investments, a further advantage of the present invention may derive from the purchase of the foreign target asset. In a preferred embodiment, the asset purchase comprises the issuance of a bond by the target company to the VCLP in exchange for purchase money, payable by the target company with interest set at a prescribed fixed or variable rate. In a preferred embodiment, the bond is in the form of a convertible note, which the VCLP can convert into stock or cash at the election of the investors. Thus, not only are the performance earnings and cashflows of the company receivable by the ultimate investors (partners and their parents) as capital gains, but the interest paid by the target company on the principal payback of the money invested in the company is fully tax exempt, which results in financial performance improvements for the company and greater return on investment by the VCLP partners and upstream entities. If the operating structure combination of the present invention is not used, only a proportion of the target company's interest expense maybe fully tax-deductible, and only when certain funding and investment process criteria are met.

One of ordinary skill in the art will readily appreciate the benefits of the investment model of the present invention over that of traditional investment strategies, including but not limited to direct investment by nationals of one country in businesses organized under another, which include the inherent risks of foreign governance law, currency exchange and interest rate volatility and tax liabilities. While hedging strategies, e.g., purchasing foreign currency in advance of a transaction or at regular intervals suitable to business needs in order to lock in rates that are acceptable, are known in the art, the currency swap strategy of the present invention synchronizes with a search fund investment timeline, enabling the searcher to identify an investment that is believed to have adequate cashflow to justify the exercise of the swaption agreed upon previously to fund the foreign investment. This is a way to eliminate full principal currency risk prior to entering into a major asset purchase in a suitable foreign jurisdiction. It is an object of the present invention to enable foreign investments subject to certain criteria with substantially more risk mitigation that what is currently known in the art. It is the Applicant's belief that the invention described herein has not been practiced or suggested before and represents a new and useful way to stimulate and engage in foreign investment.

The invention described herein is that of a method which requires a very specific series of steps to be executed. The steps are formal and concrete in nature. The invention does not describe an abstract idea of how to achieve its benefits, but rather the steps that are required to be carried out to achieve those benefits.

What is claimed is:

1. A method of investing in a foreign target asset consisting of:
forming a first legal entity in a first sovereign jurisdiction, wherein the legal entity does not pay income tax directly to the first sovereign jurisdiction and the principal investor operates the entity;
entering the first legal entity into a limited partnership with at least one general partner and optionally one or more additional limited partners, wherein the general partner is organized under the laws of a second sovereign jurisdiction;
wherein the limited partnership invests money, in the currency of the second sovereign jurisdiction, in a target entity organized under the laws of the second sovereign jurisdiction;
wherein the currency of the second sovereign jurisdiction is procured from an entity residing in the second sovereign jurisdiction in exchange for an agreed upon amount of currency of the first sovereign jurisdiction;
wherein each of the currency of the first sovereign jurisdiction and the currency of the second sovereign jurisdiction are exchanged subject to repayment of the same with interest set at agreed upon rates.

2. The method of claim 1, wherein the first legal entity is a limited liability company and the first sovereign jurisdiction is a State within the United States of America.

3. The method of claim 2, wherein the second sovereign jurisdiction is the Commonwealth of Australia.

4. The method of claim 3, wherein the currency of the first sovereign jurisdiction is exchanged for the currency of the second sovereign jurisdiction under a currency swap option agreement.
